(19) United States
(12) Patent Application Publication
(10) Pub. No.: US 2026/0327523 A1
(43) Pub. Date: Oct. 22, 2026

(54) LAUNDRY SOLID SLAB-DETERGENT AND RELATED MANUFACTURING METHOD

(71) Applicant: ZOBELE HOLDING S.P.A., Trento (IT)

(72) Inventors: Victoria CHEPTENE, Trento (IT); Giampaolo FERRONATO, Trento (IT); Maurizio MOTTA, Trento (IT); Marco OLIVA, Trento (IT)

(21) Appl. No.: 19/486,821

(22) PCT Filed: May 27, 2024
(86) PCT No.: PCT/IB2024/055127

§ 371 Date: Nov. 21, 2025

(30) Foreign Application Priority Data
May 31, 2023 (IT) 102023000011130

(51) Int. Cl. C11D 3/395; C11D 1/14; C11D 1/66; C11D 1/83; C11D 3/386; C11D 3/39; C11D 3/50; C11D 11/00; C11D 17/00

(52) U.S. Cl. CPC C11D 3/3953; C11D 1/83; C11D 3/38609; C11D 3/38627; C11D 3/3917; C11D 3/3942; C11D 3/50; C11D 11/00; C11D 17/0065; C11D 1/143; C11D 1/146; C11D 1/662; C11D 1/667

(57) ABSTRACT

Laundry solid slab-detergent consisting of a basic formulation and possibly other functional additives, wherein said basic formulation includes:—from 20% to 80% of surfactants selected from anionic surfactants and non-ionic surfactants; —from 10% to 40% of bleaches, selected from inorganic peroxides; —up to 10% of organic activators of inorganic peroxides, selected from TAED and TAHD; —up to 10% of a mixture of enzymes, selected from protease, amylase and lipase; and—up to 5% of a fragrance; wherein said slabs of the slab-detergent have a thickness, a length and a width and said thickness is equal to or less than ⅕ of the lesser of the length or width of said slab, wherein said enzymes are predominantly contained within the thickness of said slabs and wherein their water content is less than 10% and preferably less than 5%.

### FIELD OF THE INVENTION

The present invention relates, in a first aspect, to a laundry solid slab-detergent and, in a second aspect, to a manufacturing method of said slab-detergent. In particular, the invention relates to a laundry solid slab-detergent, containing heat-sensitive substances, capable of rapidly dissolving even in cold water, and suitable for both laundry an automatic washing machine and hand washing.

### PRIOR STATE OF THE ART

The audience of consumers is now increasingly informed about the ecological footprint of the products it purchases. Awareness of the need to reduce water consumption, where its use is not strictly necessary, directs therefore consumers to look favourably towards formulations of solid detergents with no water. Furthermore, a reduction in the amount of water contained in detergents brings with it various advantages; among these, a lower weight of a water-free detergent, which allows to reduce transport costs and to facilitate the retailer and the consumer too in moving and handling detergents.

Given these advantages, several examples of water-free solid sheet detergent have already been available on the market for some time. However, the method currently in use for the manufacture of such detergents necessarily requires at least one step at fairly high temperatures (120°-170 °C), namely the step of drying the aqueous mixture of the detergent components. This step is carried out downstream of a preliminary step wherein the detergent components are formed in an aqueous mixture after addition of water and such aqueous mixture is spread as a film on a flat surface where it is dried. For this reason, the use of heat-sensitive substances dispersed in the mass of a solid sheet detergent is currently completely barred, since such substances would be immediately degraded or otherwise inactivated during the manufacturing method itself. U.S. Pat. No. 9,464,264 (2016) describes a method and related apparatus for manufacturing a sheet detergent of the type illustrated above.

In order to overcome this drawback, which has so far significantly limited the field of application of sheet detergents—considering that many heat-sensitive additives, including for example enzymes, bleaches and perfumes, are essential to improve the effectiveness of a detergent—in the known art it has already been proposed to carry out a post-addition of the heat-sensitive additives on the detergent film leaving the drying step, thus making said additives integral with the film through the use of adhesive substances or by permeation of the heat-sensitive additives within the thickness of the film. However, such a solution entails the collateral drawback of leaving a substantial part of the heat-sensitive additives exposed on the surface of the sheet detergent and therefore in direct contact with the user; this solution is therefore not acceptable, on the side of consumer protection, since said heat-sensitive additives often consist of or include allergenic products.

Another critical issue associated with the water-free solid sheet detergents currently available on the market is the low amount of active substances (active in the washing process) that said detergents can contain. The currently known water-free solid sheet detergents must in fact necessarily a have sufficiently low thickness to make it possible to carry out the drying step in acceptable times, and furthermore in such low thickness there must also be contained a high amount of film-forming components, usually based on PVA or PVOH, which therefore take a high percentage weight of the finished product, leaving a limited space for the active substances. In addition, the environmental impact of these film-forming components has an importance that is not yet clearly assessed; the use of such film-forming components in high percentages raises therefore some concern.

Further technical solutions for associating heat-sensitive additives with a sheet detergent have been disclosed by US-2019/093057 and U.S. Pat. No. 11,193,097. Both these solutions involve coupling two sheets of detergent to form a sandwich, inside which the heat-sensitive additives are enclosed. However, in both cases the use of special components is provided, which use therefore causes a certain complication and a higher cost of the detergent manufacturing process. In US-2019/093057 the heat-sensitive additives must be previously formed as solid granular components; while in U.S. Pat. No. 11,193,097 the sheet detergent must contain a water-soluble fibrous component. Both these solutions are in fact aimed at preventing an early weakening of the structure of the sheet detergent by the additives enclosed in the sandwich or, more precisely, by the aqueous component of such additives.

In any case, none of these previous documents proposes a detergent which is actually water-free even in its manufacturing step, since a preliminary dissolution in water of the detergent components is always required, which water must be then removed in a final drying step, to obtain the water-free solid sheet detergent.

EP 3 732 278, in the name of the same Applicant, discloses a bleaching additive in pellets for laundry detergents, obtained through an extrusion process, with a sticky surfactant, a high molecular weight water-soluble polymer and a plasticizer, wherein the bleaching agent is protected from the external environment and from direct contact with the user by the polymeric structure of the pellet.

The problem addressed by the present invention is therefore to provide a solid detergent which is effectively of the water-free type, i.e. which does not require any addition of water, not even during the manufacturing step, and which can also include thermolabile additives and a higher amount of substances active in the washing process.

When addressing this problem, a first object of the invention is to provide a water-free solid detergent which has good washing performance even at low temperatures.

A second object of the invention is to provide a water-free solid detergent, wherein heat-sensitive additives are also present and such heat-sensitive additives are mainly dispersed within the thickness of the solid detergent.

A third object of the invention is to provide a water-free solid sheet detergent wherein the ratio of substances active in the washing process to the other substances contained in the detergent formulation is increased, and wherein it is also possible to increase the thickness of the sheets as desired, to increase the content of active substances in a unit dose of detergent.

Another object of the invention is to provide a manufacturing method of a solid detergent without added water, i.e. wherein it is not included an initial step of adding water to obtain a homogeneous spreadable mixture of the different detergent components, and therefore a final drying step is not necessary to form the detergent.

A further object of the invention is also to provide a manufacturing method of a solid slab-detergent without added water which gives the slab-detergent high compactness and resistance to handling.

### SUMMARY OF THE INVENTION

This problem is solved, and these objects achieved, by means of a water-free solid slab-detergent having the features defined in claim 1, and by a manufacturing method of said having features the defined in claim 5. Other detergent preferred features of the solid slab-detergent according to the invention and of the related manufacturing method are defined in the secondary claims.

Further features and advantages of the water-free solid slab-detergent according to the present invention and of the related manufacturing method will anyhow become more evident from the following detailed description of some preferred embodiments of the same illustrated in the accompanying Examples, given by mere way of non-limiting example of the invention.

### DETAILED DESCRIPTION OF A PREFERRED EMBODIMENT

According to the present invention, to solve the technical problem described above by means of a simple and immediately applicable solution, a is water-free solid slab-detergent obtained through a manufacturing method entirely carried out at room temperature.

The term “water-free” in the present description means that the water content in the detergent of the invention is less than 10%, and preferably equal to or less than 5%.

The term “slab-detergent” in the present description means a detergent in laminar form a with dimension (the slab thickness) which is equal to or less than ⅕, preferably less than 1/10 and more preferably less than 1/20 of the lesser of the two other dimensions (length and width).

According to an important feature, the water-free solid slab-detergent according to the invention does not use film-forming agents, such as PVOH, and in this way the percentage by weight of substances active in the washing process included in the detergent formulation can be significantly increased, for example up to 80 wt % on total weight of the detergent formulation. Furthermore, the method for preparing the water-free solid slab-detergent of the invention does not involve the addition of water, but only the use of solid and liquid components in appropriately balanced ratios, to obtain a weight ratio of water in the final product that falls within the limits indicated above, without addition of process water. Therefore, there is no drying step of the product, so that the slab-detergent of the present invention can be formed into slabs, that is, into flat elements having a thickness significantly higher than that of the sheet detergents present on the market, and therefore having a proportionally much higher content of substances active in washing.

The individual components which make up the basic formulation of the water-free detergent and the most frequently used functional additives are described in detail below, with their respective weight percentage ranges compared to the total weight of the final solid slab-detergent. The basic formulation of the water-free solid slab-detergent according to the present invention makes it possible to wash fabrics off various dirt residues, oily, greasy, protein stains and other types of particles, with performances comparable to traditional powder or liquid detergents for heavy duty. The components of such basic formulation are surfactants, inorganic peroxides, peroxide activators, enzymes and perfumes. All percentages indicated below are weight percentages related to the total weight of the detergent formulation.

### Surfactants

The water-free detergent of the present invention contains surfactants which can be selected from anionic surfactants, non-ionic surfactants and mixtures thereof.

Suitable anionic surfactants typically include alkyl sulphates or alkyl sulphonates. Suitable alkyl sulphonates may include alkali metal salts of C6-C8 alkyl sulphonic acids; particularly preferred is the mixture of C6-C8 sodium sulphonates commercially available under the name BIO-TERGE PAS 7S (CAS 2832-45-3).

Other alkyl sulphonates may be in the form of ammonium salts, such as ammonium alkyl sulphonates with 12-14 carbon atoms, particularly preferred is the product commercially available under the name SULFETAL LA B-E (CAS 90583-11-2).

Other sulphonates which can be used as surfactants in the detergent of the present invention are the linear alkylbenzenesulphonates known as “LAS”, with an alkyl chain generally comprising 10 to 14 carbon atoms. Particularly preferred are linear alkylbenzenesulphonates associated with metal cations such as sodium or potassium.

The solid slab-detergent of the present invention may further contain functionalized derivatives of glycerol, such as a glycerol-derived ether, known as glycereth. Glycereth is preferably included in the detergent in a form esterified with fatty acids contained in coconut. A preferred commercially available product of this type is LEVENOL F 200 (CAS 68201-46-7).

Furthermore, it is possible to use monosaccharide-based surfactants. Preferably, monosaccharides functionalized with alkyl chains are used. More preferably, monosaccharides are used wherein only the anomeric position of the monosaccharide is an functionalized with alkyl chain ether. Examples of surfactants of this type are the commercially available mixtures MILCOSIDE 301-V2 and SIMULSOL SL 7 G.

The formulation for the production of the water-free solid slab-detergent of the present invention contains total surfactants in the range 20% to 80%, and more preferably 30% to 60%.

### Bleaches

The basic formulation of the present invention may include one or more inorganic peroxides as bleaching components, for example it may include peroxides, salts of inorganic peroxides, such as alkali metal salts, sodium salts of percarbonates, perborates, persulphates, perphosphates or persilicates, which produce hydrogen peroxide in aqueous solution.

Sodium percarbonates, generally corresponding to the formula 2Na₂CO₃·3H₂O₂, are particularly preferable due to their greater dissolution rate and high effectiveness relative to weight. Furthermore, they have a more ecological behaviour and the advantage of generating hydrogen peroxide, simultaneously releasing sodium carbonate.

On the other sodium hand, percarbonates have the disadvantage that, in the presence of hardness builders which can absorb humidity and then release it, they tend to decompose with subsequent loss of active oxygen, thus reducing their whitening effect. However, in the present invention the sodium percarbonate stability is improved thanks to the manufacturing method which allows the inclusion of this component too within the thickness of the slab-detergent.

The formulation for the manufacture of the water-free solid slab-detergent of the invention typically contains inorganic peroxides in the range 10% to 40%.

### Activators or Precursors

An inorganic persalt activator, or an organic peroxide compound precursor, is any organic compound capable of reacting in aqueous solution with a compound containing an inorganic peroxide to form an organic peroxide compound which has a whitening efficacy, at a temperature equal or lower than 60 °C, which is at least equivalent to that of a compound containing an inorganic peroxide, under the same conditions.

Suitable peroxide activating compounds can be selected from the group consisting of anhydrides, esters, oximes, chlorophormates and cyano-containing compounds. The preferred classes are N-acetylated compounds. In particular, the preferred activators are N—,N,N′,N′ tetra acetyl ethylene diamine (TAED) and other N—,N,N′,N′ tetra-acetylated compounds, such as tetra acetyl hexylene diamine (TAHD). The most preferred persalt activator is TAED.

The formulation for the manufacture of the water-free solid slab-detergent of the invention contains less than 10% organic activators of peroxide bleaches.

### Enzymes

As is known, enzymes are particularly heat-sensitive molecules, and must be excluded from detergent formulations, precisely because of their thermolability, when high temperature steps are involved in the detergent manufacturing method, typically the drying steps of the slab-detergents of known type.

However, the inclusion of enzymes in the formation of detergents allows to enhance their washing capabilities, especially in washing cycles at temperatures below 60 °C, and for the removal of stains; enzymes, in fact, break bonds of different classes of molecules. Protease, amylase and lipase are used in the present invention.

Particularly preferred are the enzyme mixtures for detergents marketed by Novozymes. Preferably, the product MEDLEY PURE 100T is used. The water-free slab-detergent formulation of the present invention contains up to 10% and more preferably up to 5% of said enzyme mixture.

### Functional Additives

Finally, it is possible to add some secondary components (functional additives) to the basic formulation of the water-free solid slab-detergent, to adapt the formulation to specific needs.

For example, builders, such as trisodium citrate or zeolites, can be added. When included, builders may be in the range 5% to 15% of the detergent formulation of the invention.

Additionally, a softening agent can be used, such as maltodextrin. If included, the softening agent may be in a range up to 5% of the detergent formulation of the invention.

Additionally, anti-foaming agent blends can be used, such as XIAMETER APW 4248. If included, the anti-foaming agent blends may be in a range up to 5% of the detergent formulation of the invention.

In addition, it is possible to use optical brighteners, such as disodium 2,2′-([1,1′-diphenyl]-4,4′-diyldivinylene)bis-benzenesulphonate, for example marketed under the name CBS-X by ALCOBRIGHT. If included, the optical brighteners may be in a range up to 5% of the detergent formulation of the invention.

In addition, suspending agents can be used, such as for example carboxymethylcellulose sodium salt. If included, the suspending agents may be in a range up to 5% of the detergent formulation of the invention.

In addition, other salts can also be used, preferably an inorganic salt such as sodium chloride, to impart rigidity and structure to the slab-detergent and thus improve its handling. The addition of hygroscopic salts such as sodium chloride allows the ambient humidity to be absorbed onto them, thus protecting the enzymes and percarbonate during the slab-detergent shelf-life. If included, the other salts may be in a range 5% to 15% of the detergent formulation of the invention.

Finally, the detergent may also contain a fragrance to give a pleasant scent to the laundry. The fragrance can be added as a free-oil or as a microcapsulated fragrance (i.e., a liquid fragrance contained in water-soluble microcapsules). The water-free slab-detergent of the present invention may contain fragrance in a range up to 5%.

The different components which can be used in the formulation of solid slab-detergent of the present invention are summarized in Table 1 below, together with preferred percentage ranges of the same.

TABLE 1

| | | min | max |
|---|---|---|---|
| Component | Function and chemical name | wt % | wt % |
| BIO-TERGE PAS 7S | Anionic surfactant - Alkane C6-C8 1- | 15% | 30% |
| | sulphonic acid, sodium salt | | |
| SULFETAL LA B-E | Anionic surfactant - Mono-C12-14- | 5% | 15% |
| | alkyl esters of sulphuric acid, | | |
| | ammonium salts | | |
| LEVENOL F 200 | Non-ionic surfactant - Glicereth | 5% | 15% |
| | cocoate | | |
| PG7G SIMULSOL | Non-ionic surfactant - D- | | 5% |
| SL7 G | Glucopyranose, oligomer, heptyl | | |
| | glycoside | | |
| MILCOSIDE 301 V2 | Non-ionic surfactant - Decyl | | 5% |
| | glucoside | | |
| Sodium percarbonate | Bleach - Sodium percarbonate | 10% | 40% |
| TAED | Activator - Tetraacetylethylenediamine | | 10% |
| MEDLEY PURE 100T | Enzymes - Mixture of protease, | | 10% |
| | amylase and lipase. | | |
| Trisodium citrate | Builder additive - Trisodium citrate | 5% | 15% |
| | dihydrate | | |
| Zeolites | Builder additive - Zeolite | 5% | 15% |
| Maltodextrin | Fabric softener - Maltodextrin | 5% | 15% |
| XIAMETER APW 4248 | Anti-foam additive | | 5% |
| ALCOBRIGHT CBS-X | Optical brightener additive - | | 5% |
| | Disodium 2,2′-([1,1′-diphenyl]-4,4′- | | |
| | diyldivinylene)bis(benzenesulphonate) | | |
| CMC | Suspending additive - | | 5% |
| | Carboxymethylcellulose, sodium salt | | |
| Fine salt | Structuring and hygroscopic additive - | 5% | 15% |
| | sodium chloride | | |
| | Fragrance | | 5% |

### FORMULATION EXAMPLES

The present invention is further illustrated by the following examples, which are not intended as limiting the scope of protection of the invention, but only as illustrative of some preferred detergent formulations which are different embodiments of the same:

### Example 1

| Component | Function | Wt % |
|---|---|---|
| BIO-TERGE PAS 7S | Anionic surfactant | 20.0% |
| SULFETAL LA B-E | Anionic surfactant | 10.0% |
| LEVENOL F 200 | Non-ionic surfactant | 8.0% |
| PG7G SIMULSOL SL7 G | Non-ionic surfactant | 4.0% |
| MILCOSIDE 301 V2 | Non-ionic surfactant | 4.0% |
| Sodium percarbonate | Peroxide | 16.0% |
| TAED | Activator | 4.0% |
| MEDLEY PURE 100T | Enzymes | 1.0% |
| Trisodium citrate | Builder additive | 7.0% |
| Zeolites | Builder additive | 6.0% |
| Maltodextrin | Fabric softener | 6.0% |
| XIAMETER APW 4248 | Anti-foam additive | 1.0% |
| ALCOBRIGHT CBS-X | Optical brightener additive | 0.5% |
| CMC | Suspending additive | 1.0% |
| Fine salt | Structuring and hygroscopic | 10.5% |
| | additive | |
| | Fragrance | 1.0% |
| | | 100.0% |

### Example 2

| Component | Function | wt % |
|---|---|---|
| BIO-TERGE PAS 7S | Anionic surfactant | 22.0% |
| SULFETAL LA B-E | Anionic surfactant | 9.0% |
| LEVENOL F 200 | Non-ionic surfactant | 6.5% |
| PG7G SIMULSOL SL7 G | Non-ionic surfactant | 5.0% |
| MILCOSIDE 301 V2 | Non-ionic surfactant | 5.0% |
| Sodium percarbonate | Peroxide | 15.0% |
| TAED | Activator | 1.0% |
| MEDLEY PURE 100T | Enzymes | 2.0% |
| Trisodium citrate | Builder additive | 8.0% |
| Zeolites | Builder additive | 8.0% |
| Maltodextrin | Fabric softener | 8.0% |
| XIAMETER APW 4248 | Anti-foam additive | 2.0% |
| ALCOBRIGHT CBS-X | Optical brightener additive | 1.0% |
| CMC | Suspending additive | 1.5% |
| Fine salt | Structuring and hygroscopic | 5.2% |
| | additive | |
| | Fragrance | 0.8% |
| | | 100.0% |

### Example 3

| Component | Function | wt % |
|---|---|---|
| BIO-TERGE PAS 7S | Anionic surfactant | 16.0% |
| SULFETAL LA B-E | Anionic surfactant | 6.0% |
| LEVENOL F 200 | Non-ionic surfactant | 5.0% |
| PG7G SIMULSOL SL7 G | Non-ionic surfactant | 2.0% |
| MILCOSIDE 301 V2 | Non-ionic surfactant | 3.0% |
| Sodium percarbonate | Peroxide | 20.0% |
| TAED | Activator | 2.0% |
| MEDLEY PURE 100T | Enzymes | 1.5% |
| Trisodium citrate | Builder additive | 8.5% |
| Zeolites | Builder additive | 8.0% |
| Maltodextrin | Fabric softener | 9.0% |
| XIAMETER APW 4248 | Anti-foam additive | 1.0% |
| ALCOBRIGHT CBS-X | Optical brightener additive | 1.0% |
| CMC | Suspending additive | 2.0% |
| Fine salt | Structuring and | 13.8% |
| | Hygroscopic additive | |
| | Fragrance | 1.2% |
| | | 100.0% |

As mentioned above, the manufacturing method of solid slab-water-free detergent does not require heating steps and it is carried out at room temperature. Said manufacturing method includes a first mixing step of the different components of the formulation as detailed above, which mixing step is carried out without addition of mixing water by means of a thorough mechanical mixing process into a single-screw or, preferably, a twin-screw extruder. The mixed product leaving the screw extruder is already homogenized enough to be directly extruded in a slab shape and used as a solid slab-detergent.

However, in a preferred embodiment of the invention, the extruded material is further treated in a calender to obtain a finished product with improved surface smoothness and compactness features.

The water-free solid slab-detergent thus produced showed high dissolving/solubilization performance in short washing cycles and/or washing cycles with cold water, compared to the sheet detergents present on the market, and a significantly superior washing power, the amount of used solid detergent being equal, due to the presence of thermolabile additives and the highest percentage amount of substances active in washing (up to 80 wt %) which was possible to include in the formulation thanks to the complete absence of film-forming components which are completely inert in the washing process. Finally, precisely the complete absence of film-forming components in the solid slab-detergent of the invention radically eliminates the problem of the formation of residues and encrustations, even in the areas of washing machines where the washing water flows only occasionally or at lower speeds.

The water-free solid slab-detergent thus obtained is finally cut to size, in the different sizes required by the market, and further packaged for sale.

From the previous description, it is evident how the water-free solid slab-detergent of the present invention has achieved all the intended objects. Since, in fact, the slab-detergent contains a high percentage of enzymes inside-thanks to the fact that the relative manufacturing method is entirely carried out at room temperature and therefore does not involve any degradation of thermolabile additives, such as precisely enzymes—the detergent can provide excellent washing results for both washing machine and hand washing, and offers laundry in a excellent capabilities of dirt removal even in low temperature washes, for example at 30-40 °C. Having also completely eliminated from the formulation all film-forming compounds, the water-free solid slab-detergent of the invention can contain a much higher percentage of substances active in the washing process, the weight being the same, and can therefore provide effective washing performances already at low doses of detergent. Furthermore, it is possible to increase the thickness of the slab-detergent as desired in the extrusion and calendering processes, to correspondingly increase the dosage of active substances contained in a unit dose (slab) of slab-detergent, contrary to what happens for solid sheet detergents of known type which, due to the drying step, are limited to a low thickness.

Finally, the special selected manufacturing method, without addition of mixing water and with a thorough mechanical mixing and compacting action, besides allowing the extraordinary result of eliminating the complicated and long drying step of the known sheet detergents and avoiding the related waste of energy, also allows to obtain a slab-detergent which is particularly smooth and compact and therefore resistant to handling and with a low allergenic impact on the consumer.

However, it is understood that the invention should not be considered as limited to the specific arrangement illustrated above, which is only an exemplary embodiment thereof, but that different variants are possible, all within the reach of a person skilled in the art, without thereby departing from the scope of protection of the invention itself, as defined by the following claims.

1. Laundry solid slab-detergent consisting of a basic formulation including surfactants, bleaches, activators of said bleaches and heat-sensitive additives, and possibly other functional additives, wherein the slabs of the slab-detergent have a thickness, a length and a width, wherein said heat-sensitive additives are mainly contained within the thickness of said slabs and wherein the water content is less than 10% and preferably less than 5%, characterized in that said thickness is equal to or less than ⅕ of the lesser of said length and said width, and in that said basic formulation includes:
from 20% to 80% of surfactants selected from anionic surfactants and non-ionic surfactants;
from 10% to 40% of bleaches, selected from inorganic peroxides;
up to 10% of organic activators of inorganic peroxides, selected from TAED and TAHD; and
up to 10% of a mixture of enzymes, selected from protease, amylase and lipase.

2. Laundry solid slab-detergent according to claim 1, wherein said surfactants include from 15% to 30% of a first anionic surfactant, such as BIO-TERGE PAS 7S, from 5% to 15% of a second anionic surfactant, such as SULFETAL LA B-E, from 5% to 15% of a first non-ionic surfactant, such as LEVENOL F 200, up to 5% of a second non-ionic surfactant, such as PG7G SIMULSOL SL7 G and up to 5% of a third non-ionic surfactant, such as MILCOSIDE 301 V2.

3. Laundry solid slab-detergent according to claim 2, further including up to 5% of a fragrance.

4. Laundry solid slab-detergent according to claim 1, wherein the thickness of said slabs is equal to or less than 1/10 and preferably less than 1/20 of the lesser of said width and length.

5. Manufacturing method of a laundry solid slab-detergent consisting of a basic formulation, which includes surfactants, bleaches, activators of said bleaches and heat-sensitive additives, and possibly other functional additives, wherein components of said basic formulation and any functional additives are mixed in an extruder, without addition of mixing water, so that their water content is less than 10% and preferably less than 5%, characterized in that said extruder is a screw extruder and the obtained mixture is extruded in the form of a continuous slab of said solid slab-detergent and in that said continuous slab leaving said extruder is subjected to a compacting and smoothing treatment in a calender.

6. Manufacturing method of a laundry solid slab-detergent according to claim 5, wherein said extruder is a single-screw extruder or a twin-screw extruder.

7. Manufacturing method of a laundry solid slab-detergent according to claim 5, wherein said continuous slab of detergent leaving said calender has a thickness equal to or less than ⅕ of the lesser of its width and length.

8. Manufacturing method of a laundry solid slab-detergent according to claim 5, wherein said continuous slab of detergent coming out of said calender has a thickness equal to or less than 1/10 and preferably less than 1/20 of the lesser of its width and length.
